(19) United States
(12) Patent Application Publication
(10) Pub. No.: US 2017/0071329 A1
(43) Pub. Date: Mar. 16, 2017

(54) Oral Care System

(71) Applicant: COLGATE-PALMOLIVE COMPANY, New York, NY (US)

(72) Inventor: Kelly Gail DUNCAN, Washington, NJ (US)

(73) Assignee: COLGATE-PALMOLIVE COMPANY, New York, NY (US)

(21) Appl. No.: 15/309,184

(22) PCT Filed: May 7, 2014
(86) PCT No.: PCT/US2014/037168

§ 371 Date: Nov. 6, 2016

(51) Int. Cl. A46B 15/00; A61C 19/06; A46B 9/04

(52) U.S. Cl. CPC A46B 15/0061; A46B 9/04; A61C 19/066; A61C 19/063; A46B 2200/1066

(57) ABSTRACT

An oral care system includes a handle and a head, the handle having a proximal end, a distal end, an internal cavity, and a dispensing aperture for the internal cavity. The head is coupled to a distal end of the handle and includes at least one oral surface engaging element. One or more oral care applicators are positioned in the internal cavity. A cover may be slidably coupled to the handle so as to be translatable relative to the handle between: (1) a closed state in which the cover encloses the internal cavity; and (2) an open state in which the internal cavity is exposed. The one or more applicators may be provided in an accordion stack in the internal cavity.

### BACKGROUND

Oral care implements such as toothbrushes are typically used by applying toothpaste or dentifrice to a bristle section on the head of the toothbrush, followed by brushing regions of the oral cavity (e.g., the teeth or soft tissue such as the tongue and/or gums) with the bristle section. Furthermore, a growing cosmetic trend has been to supplement tooth brushing with the application of additional oral care materials to the user's oral cavity. However, conventional systems for applying oral care materials requires that the user maintain both a toothbrush and an additional kit for storing and dispensing the oral care material into the user's oral cavity. This not only requires extra storage space in already cramped bathroom cabinets, but also requires that the user remember to use the oral care material treatment system. Furthermore, these systems are not conveniently portable for transport and/or travel. Moreover, these known systems only apply the oral care material onto a single tooth at a time, thereby resulting in the application of the oral care material being a time consuming and ineffective process. These problems require a better way to deliver the oral care materials to the oral cavity and a more convenient oral care material application system for transport and/or travel.

### BRIEF SUMMARY

Exemplary embodiments according to the present disclosure are directed to an oral care system in which an oral care implement includes a handle having a clamshell mechanism and an applicator positioned within the clamshell mechanism.

In one aspect, the invention can be an oral care system comprising: a handle comprising a proximal end, a distal end, an internal cavity, and a dispensing aperture for the internal cavity; a head coupled to a distal end of the handle, the head comprising at least one oral surface engaging element; a plurality of oral care applicators arranged in an accordion stack that is positioned in the internal cavity, each of the plurality of oral care applicators comprising an oral care material; and a cover coupled to the handle, the cover being alterable between: (1) a closed state in which the cover encloses the internal cavity; and (2) an open state in which the internal cavity is exposed.

In another aspect, the invention can be an oral care system comprising: a handle comprising an internal cavity and a dispensing aperture for the internal cavity; one or more oral care applicators positioned in the internal cavity, the one or more oral care applicators comprising an oral care material; and a cover slidably coupled to the handle so as to be translatable relative to the handle in a direction substantially parallel to a longitudinal axis of the handle, the cover slidable between: (1) a closed state in which the cover overlies the dispensing aperture and encloses the internal cavity; and (2) an open state in which the dispensing aperture is exposed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a first embodiment of an oral care device having a cover for an internal cavity;

FIG. 2 is a perspective view of the oral care device of FIG. 1, showing an end portion of an oral care applicator being dispensed from the internal cavity;

FIG. 3 is a perspective view of an oral care applicator in an accordion stack;

FIG. 4 is an exploded view of the oral care device of FIG. 1;

FIG. 5 is a partial sectional view of the oral care device of FIG. 1;

FIG. 6 is a sectional view of the oral care device of FIG. 1 showing an end portion of an oral care applicator being extended out of the internal cavity;

FIG. 7 is sectional view of the oral care device of FIG. 1 showing an end portion of an oral care applicator being removed from the portion of the oral care applicator within the internal cavity;

FIG. 8 is a perspective view of a second embodiment of an oral care device having a cover for an internal cavity;

FIG. 9 is a perspective view of a third embodiment of an oral care device having a cover for an internal cavity;

FIG. 10 is a top plan view of an embodiment of a sealed package containing an oral care applicator; and

FIG. 11 is a sectional view of the sealed package along the line XI-XI of FIG. 10; and

FIG. 12 is a top plan view of a plurality of sealed packages connected to one another in an edge-to-edge arrangement.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of the exemplary embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. Moreover, the features and benefits of the invention are described by reference to the exemplary embodiments illustrated herein. Accordingly, the invention expressly should not be limited to such exemplary embodiments, even if indicated as being preferred. The discussion herein describes and illustrates some possible non-limiting combinations of features that may exist alone or in other combinations of features. The scope of the invention is defined by the claims appended hereto.

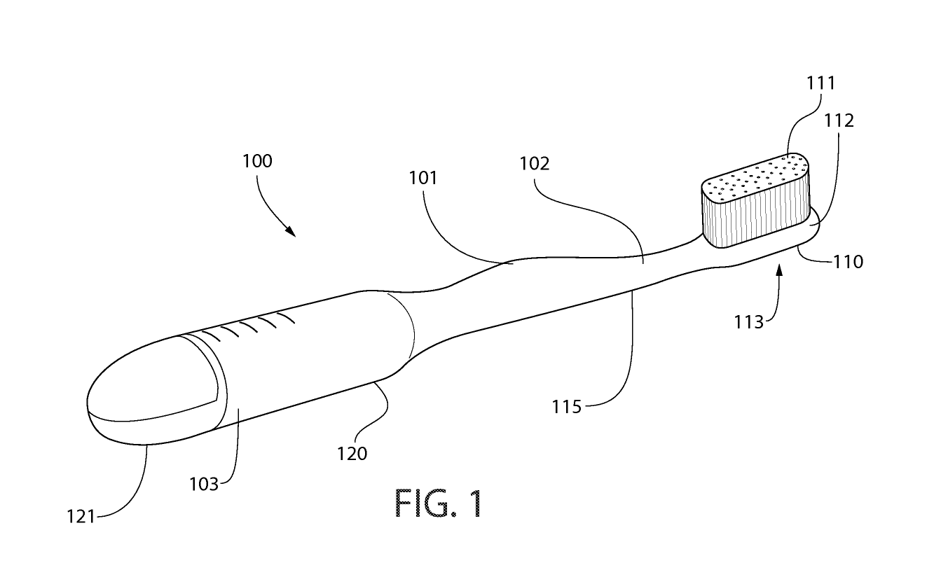

Referring first to FIG. 1, an oral care implement 100 is illustrated in accordance with an embodiment of the present invention. In this embodiment, the oral care implement 100 is in the form of a manual toothbrush. However, in other embodiments the oral care implement 100 may take on other forms such as being a powered toothbrush, a tongue scraper, a gum and soft tissue cleanser, a water pick, an interdental device, a tooth polisher, a specially designed ansate implement having tooth engaging elements or any other type of implement that is commonly used for oral care. Thus, it is to be understood that the inventive concepts discussed herein can be applied to any type of oral care implement unless a specific type of oral care implement is specified in the claims.

The oral care implement 100 generally includes an elongated body 101 comprising a head 110, a neck 115 and a handle 120. The handle 120 is an elongated structure that extends from a proximal end 103 to a distal end 102 and provides the mechanism by which the user can hold and manipulate the oral care implement 100 during use. In the embodiment shown, the handle 120 is generically depicted without contours or curvature, extending from the proximal end 103 to the distal end 102 along the longitudinal axis A, although such contours or curvatures may be incorporated into the exterior surface of the handle 120 for user comfort. Of course, in other embodiments the handle 120 may take on a wide variety of shapes, contours and configurations, none of which are limiting of the present invention unless so specified in the claims.

In the embodiment shown, the handle 120 is formed of a rigid plastic material, such as for example without limitation polymers and copolymers of ethylene, propylene, butadiene, vinyl compounds and polyesters such as polyethylene terephthalate. Of course, the invention is not to be so limited in all embodiments and the handle 120 may include a resilient material, such as a thermoplastic elastomer, as a grip cover that is molded over portions of or the entirety of the handle 120 to enhance the gripability of the handle 120 during use. For example, portions of the handle 120 that are typically gripped by a user's palm during use may be overmolded with a thermoplastic elastomer or other resilient material to further increase comfort to a user.

The head 110 of the oral care implement 100 is coupled to the handle 120 and comprises a front surface 112 and an opposing rear surface 113. In the embodiment shown, the head 110 is formed integrally with the handle 120 as a single unitary structure using a molding, milling, machining or other suitable process. However, in other embodiments the handle 120 and the head 110 may be formed as separate components which are operably connected at a later stage of the manufacturing process by any suitable technique known in the art, including without limitation thermal or ultrasonic welding, a tight-fit assembly, a coupling sleeve, threaded engagement, adhesion, or fasteners.

The head 110 of the oral care implement 100 is provided at least one oral surface engaging element, which in the embodiment shown is a plurality of tooth cleaning elements 111 extending from the front surface 112. Although in the exemplified embodiment all of the tooth cleaning elements 111 appear to be the same, the invention is not to be so limited in all embodiments. For example, in certain embodiments the tooth cleaning elements 111 include at least one bristle tuft. A bristle tuft is a collection of bristles that are positioned together into a single tuft hole formed on the head 110. Each bristle tuft may include, for example without limitation, only multi-component bristles, a combination of multi-component bristles and single-component (i.e., traditional) bristles, or only single-component bristles. The structure, pattern, orientation and material of the tooth cleaning elements 111 is not to be limiting of the present invention unless so specified in the claims.

As used herein, the term “oral surface engaging element” is used in a generic sense to refer to any structure that can be used to clean, polish or wipe the teeth and/or soft oral tissue (e.g. tongue, cheek, gums, etc.) through relative surface contact. Common examples of “oral surface engaging elements” include, without limitation, bristle tufts, filament bristles, fiber bristles, nylon bristles, spiral bristles, rubber bristles, elastomeric protrusions, flexible polymer protrusions, combinations thereof and/or structures containing such materials or combinations. Suitable elastomeric materials include any biocompatible resilient material suitable for uses in an oral hygiene apparatus. To provide optimum comfort as well as cleaning benefits, the elastomeric material of the tooth or soft tissue engaging elements has a hardness property in the range of A8 to A25 Shore hardness. One suitable elastomeric material is styrene-ethylene/butylene-styrene block copolymer (SEBS) manufactured by GLS Corporation. Nevertheless, SEBS material from other manufacturers or other materials within and outside the noted hardness range could be used.

The tooth cleaning elements 111 in the embodiment shown can be connected to the head 110 in any manner known in the art. For example, staples/anchors, in-mold tufting (IMT) or anchor free tufting (AFT) could be used to mount the cleaning elements/tooth engaging elements. In certain embodiments, the invention can be practiced with various combinations of stapled, IMT or AFT bristles. In AFT, a plate or membrane is secured to the brush head such as by ultrasonic welding. The bristles extend through the plate or membrane. The free ends of the bristles on one side of the plate or membrane perform the cleaning function. The ends of the bristles on the other side of the plate or membrane are melted together by heat to be anchored in place. Any suitable form of cleaning elements may be used in the broad practice of this invention. Alternatively, the bristles could be mounted to tuft blocks or sections by extending through suitable openings in the tuft blocks so that the base of the bristles is mounted within or below the tuft block.

In the embodiment shown, the head 110 of the oral care implement 100 includes a plurality of tuft holes (not visible) formed therein. A plurality of tufts of bristles are positioned within and affixed to the head 110 within each of the tuft holes. Each of the tufts of bristles includes a plurality of bristles, which can be single strand bristles, double strand multi-component bristles, triple strand multi-component bristles, etc. or various combinations thereof. Thus, each tuft of bristles may include only single strand bristles, or only double strand multi-component bristles, or only triple strand multi-component bristles, or any combination of single strand bristles, double strand multi-component bristles, and triple strand multi-component bristles. Additionally, a single tuft hole may be filled with an elastomeric cleaning element or any of the other types of cleaning elements noted above.

Although not illustrated herein, in certain embodiments the head 110 may also include an oral surface engaging element coupled to or positioned on the rear surface 113, such as a soft tissue cleanser. An example of a suitable soft tissue cleanser that may be used with the present invention and positioned on the rear surface of the head 110 is disclosed in U.S. Pat. No. 7,143,462, issued Dec. 5, 2006 to the assignee of the present application, the entirety of which is hereby incorporated by reference. In certain other embodiments, the soft tissue cleanser may include protuberances, which can take the form of elongated ridges, nubs, or combinations thereof. Of course, the invention is not to be so limited and in certain embodiments the oral care implement 100 may not include any soft tissue cleanser.

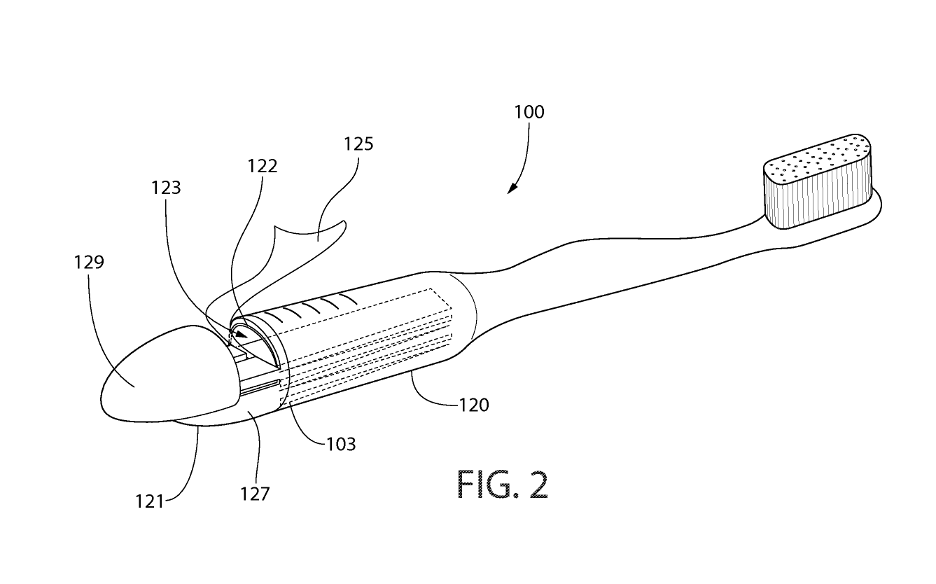

In the embodiment shown, a cover 121 is coupled to the distal end 102 of the handle 120. As seen in FIG. 2, the cover 121 encloses an internal cavity 123 of the handle 120 at a dispensing aperture 122. The cover 121 has a closed state and an open state. In the closed state, the internal cavity 123 is enclosed by the cover 121 (shown in FIG. 1). In comparison, the open state of the cover 121 provides access to the internal cavity so that a user may remove at least a portion of the oral care applicator positioned 125 therein (shown in FIG. 2).

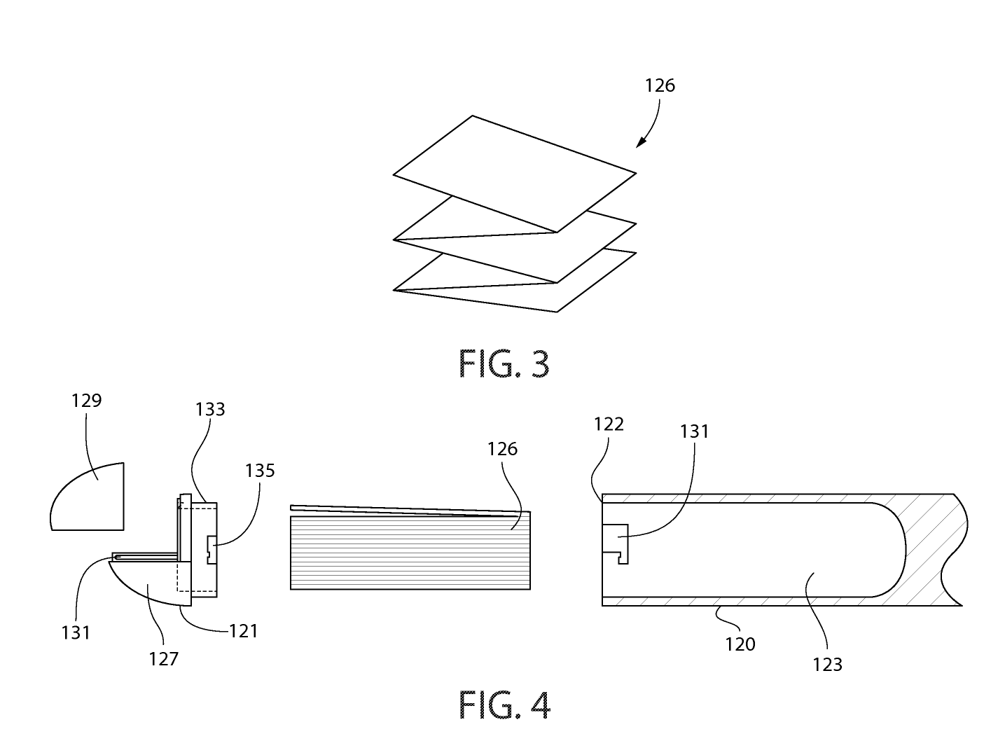

In certain embodiments, the oral care applicator 125 may be one continuous strip folded in an accordion stack 126, as shown in FIG. 3. In alternative embodiments, the oral care applicator 125 may include a plurality of strips connected together in an end-to-end arrangement with perforations, fold lines, or other separation enabling features, separating adjacent strips. In yet other embodiments, the oral care applicator 125 may include strips adhered to substrate layers, and in still other embodiments, the oral care applicator 125 may be enclosed in sealed packages. These are exemplified embodiments of the oral care applicator 125, and they are not intended to be limiting of the present invention unless so specified in the claims.

In certain embodiments, the oral care applicator 125 is loaded with an oral care material on at least the surface of the oral care applicator 125. In other embodiments, the user loads the oral care applicator 125 with an oral care material once the user removes the oral care applicator (or a portion thereof) from the internal cavity 123. In certain embodiments, the oral care material may be in liquid form. In certain other embodiments, the oral care material may be in a solid, or semi-solid form, to be hydrated by saliva or by dipping in water In certain embodiments where both a teeth whitening material and a desensitizing material are included, the two materials are preferably in the same form (i.e., a dry state or a wet state) prior to use.

In certain embodiments, solid whitening materials may be employed as the oral care material, and some suitable solid whitening materials include peroxides, metal chlorites, perborates, percarbonates, peroxyacids, persulfates, and combinations thereof. Suitable peroxide compounds include hydrogen peroxide, urea peroxide, calcium peroxide, and mixtures thereof. Suitable metal chlorites include calcium chlorite, barium chlorite, magnesium chlorite, lithium chlorite, sodium chlorite, and potassium chlorite.

In certain embodiments, a desensitizing material may be employed as the oral care material, and the desensitizing material may be solid materials, and some suitable desensitizing materials include potassium nitrate, other potassium salts, citric acid, citrates, strontium chloride, sodium fluoride, and stannous fluoride, such as are known in the art.

In still other embodiments, different oral care materials can be utilized with the present invention. Contemplated oral care materials include without limitation, antibacterial agents; oxidative or whitening agents; enamel strengthening or repair agents; tooth erosion preventing agents; tooth sensitivity ingredients; gum health actives; nutritional ingredients; tartar control or anti-stain ingredients; enzymes; sensate ingredients; flavors or flavor ingredients; breath freshening ingredients; oral malodor reducing agents; anti-attachment agents or sealants; diagnostic solutions; occluding agents, dry mouth relief ingredients; catalysts to enhance the activity of any of these agents; colorants or aesthetic ingredients; and combinations thereof. Although in some embodiments the oral care material may be a dentifrice, the oral care material is preferably free of (i.e., is not) dentifrice in some other embodiments. Instead, in such embodiments the oral care material is intended to provide benefits in addition to merely brushing one's teeth. Other suitable oral care materials could include lip balm or other materials that are typically available in a semi-solid state. Furthermore, in still other embodiments the oral care material can be a natural ingredient, such as for example without limitation, lotus seed; lotus flower, bamboo salt; jasmine; corn mint; camellia; aloe; gingko; tea tree oil; xylitol; sea salt; vitamin C; ginger; cactus; baking soda; pine tree salt; green tea; white pearl; black pearl; charcoal powder; nephrite or jade and Ag/Au+.

In certain embodiments, the oral care applicator 125 is a substrate with the oral care material loaded on one or both surfaces of the substrate. The substrate may be in the form of a film, a non-woven, or any other materials that is appropriate for this application. The substrate may formed to have a width dimension suitable to cover a row of teeth (upper or lower), or both upper and lower. Therefore, the oral care applicator may be applied to the upper set of teeth, or to the lower set of teeth either separately or simultaneously. The length dimension of the substrate may be predetermined by the amount of coverage desired, or the length dimension may be selected by the user upon removal from the internal cavity. In this regard, the number of teeth to which it is desired to apply the oral care material will determine the dimensions of the oral care applicator. For instance, it may be desired to only apply a teeth whitening material to the front teeth, which are most easily seen by others. Accordingly, the length of a whitening strip can be reduced in this case, as compared to the case where it is desired to whiten all of the teeth. The duration of application of whitening strip to the teeth will depend upon the type and concentration of the whitening agent, as well as the type and intensity of stain. In still other embodiments, the substrate may be affixed to another substrate layer, with the oral care material disposed between the substrate and the other substrate layer. One such embodiment is discussed in more detail below.

In the exemplified embodiment, the cover 121 includes a first body portion 127 and a second body portion 129. The first and second body portions 127, 129 slidably engage each other, so that the cover 121 is alterable between the closed state and the open state. As shown, the second body portion 129 is slidably movable with respect to the first body portion 127 so that the internal cavity is enclosed when the cover 121 is in the closed state. In certain embodiments, such as is shown in FIG. 4, the first and second body portions 127, 129 are slidably engaged by inclusion of grooves 131 on the first body portion 127. The grooves 131 engage complementary pins or protuberances (not shown) on the interior walls of the second body portion 129. The particular manner in which the first body portion 127 and the second body portion 129 are slidably engaged with each other is not intended to be limiting of the present invention unless so specified in the claims. In certain embodiments, the first body portion 127 may be formed integrally with the handle 120, and in such an embodiment the first body portion would be slidably engaged with the handle and movable between a closed state and an open state to enclose and allow access to, respectively, the internal cavity of the handle.

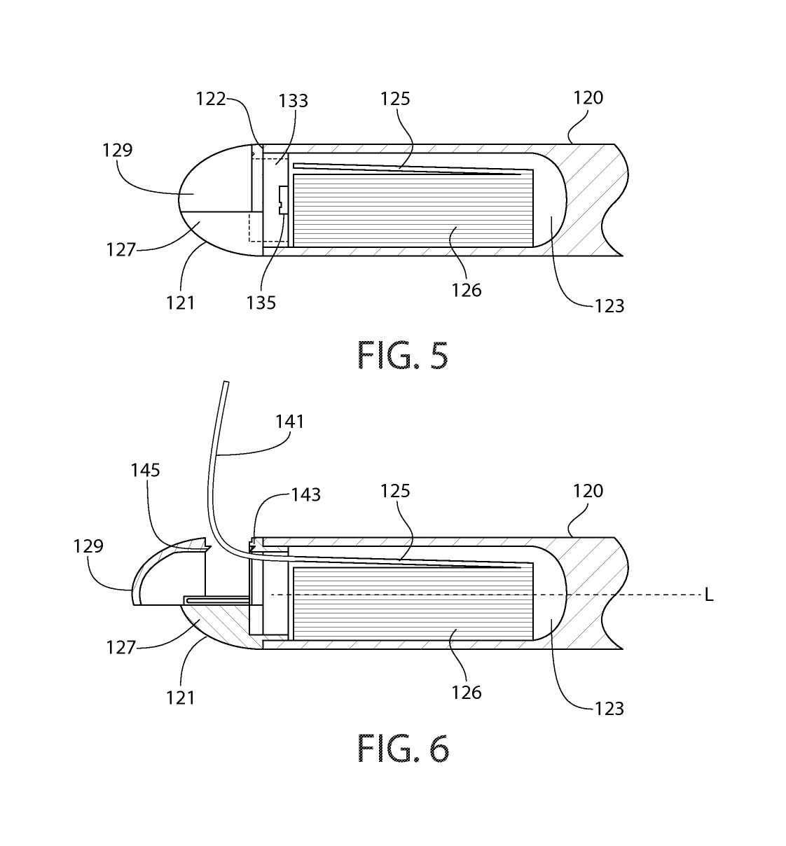

The first body portion 127 also includes cylindrical section 133 which is sized in diameter to allow it to fit through the dispensing aperture 122 to seat within the internal cavity 123 of the handle 120. The first body portion also includes, on the exterior of the cylindrical section 133, first engagement features 135, which are configured to engage second engagement features 137 located within the internal cavity 123. The first and second engagement features 135, 137 are each configured in a complementary manner so that the first engagement features 135 engage the second engagement features 137 when the cover 121 is in place on the distal end 103 of the handle 120, thereby retaining the cover in place. FIG. 5 shows the distal end 103 of the handle 120 with cylindrical section 133 of the first body portion 127 seated within the internal cavity 123, so that the first and second engagement features 135, 137 are holding the cover 121 in place.

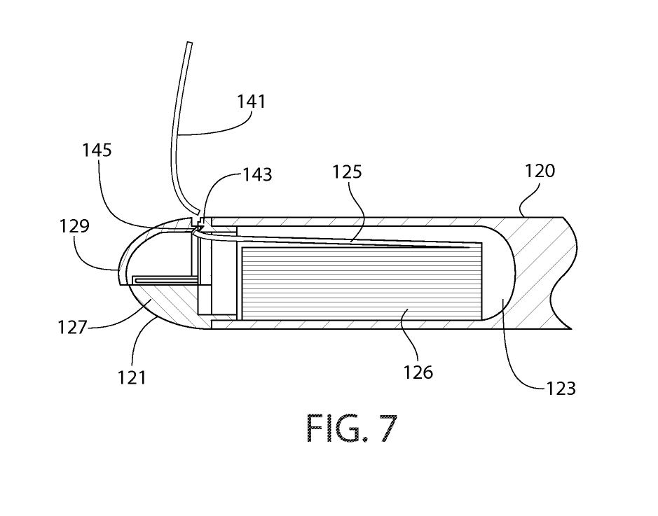

FIGS. 6 and 7 illustrate the action of the cover 121 as it is altered between the open state and the closed state for removal of an end portion 141 of the oral care applicator 125 from the accordion stack 126 positioned within the internal cavity 123. As shown in FIG. 6, the second body portion 129 of the cover 121 is translatable in a direction substantially parallel to the longitudinal axis A of the handle 120 to place the cover 121 in the open state, and in this open state, a user may remove the end portion 141 of the oral care applicator 125 from the internal cavity 123. Once the end portion 141 of the oral care applicator 125 extends away from the cover 121 and the handle 120, the second body portion 129 of the cover 121 may be translated back to the closed state, as is shown in FIG. 7. To facilitate separating the end portion 141 of the oral care applicator 125 from the rest of the oral care applicator 125 that remains in the accordion stack 126, the first body portion 127 includes a first engagement surface 143, and the second body portion 129 includes a second engagement surface 145, both positioned to engage the oral care applicator 125 as the oral care applicator 125 is drawn out of the internal cavity 123. In certain embodiments, the oral care applicator 125 may be drawn out of the internal cavity 123 to a pre-marked position on the oral care applicator 125, wherein the pre-marked position may be denoted by a discoloration, a perforation, a fold, or any other marking, such markings being used to indicate to the user a position on the oral care applicator 125 at which an end portion thereof may or is intended to be removed.

As the cover 121 is altered from the open state to the closed state, by the sliding of the second body portion 129 in this embodiment, both the first and second engagement surfaces 143, 145 engage the oral care applicator 125. In the embodiment shown, the oral care applicator 125 is engaged directly between the first and second engagement surfaces 143, 145, so that the user may then separate the end portion 141 of the oral care applicator 125 from the rest of the oral care applicator 125 remaining in the accordion stack 126. The manner in which the first and second engagement surfaces 143, 145 engage the oral care applicator 125 may vary, depending upon the particular implementation. In certain embodiments, the first and second engagement surfaces 143, 145 may clamp the oral care applicator 125 directly between two surfaces. In other embodiments, the first and second engagement surfaces 143, 145 may hold the oral care applicator 125 in place between two surfaces without clamping. In yet other embodiments, one or both of the first and second engagement surfaces 143, 145 may include a cutting edge. The configuration of the first and second engagement surfaces 143, 145 are not intended to be limiting of the present invention unless so specified in the claims.

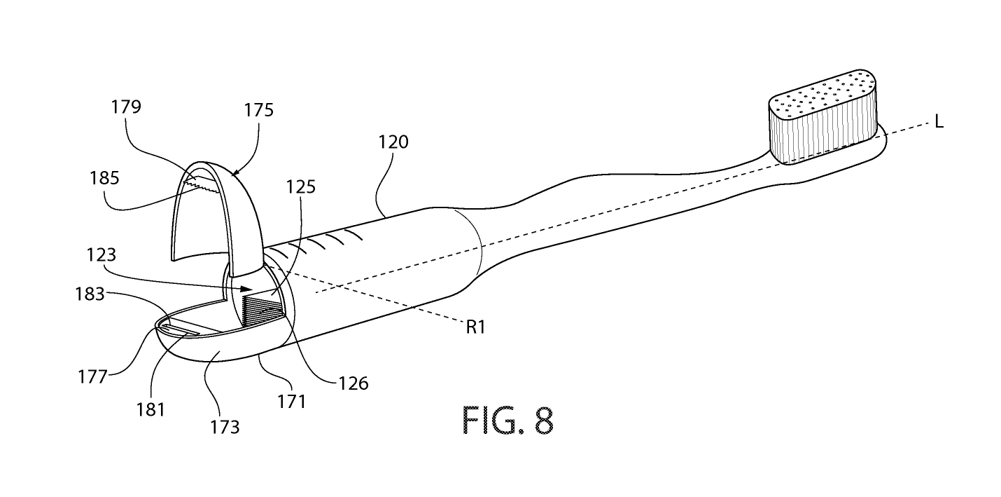

In the embodiment shown in FIG. 8, the cover 171 includes a first body portion 173 and a second body portion 175, and the first and second body portions 173, 175 are pivotably coupled to each other about a longitudinal axis L. The pivot axis R1 for the first and second body portions 173, 175 is orthogonal to the longitudinal axis L of the handle 120. By pivoting the second body portion 175 to the open state, the user is given access to the accordion stack 126 of the oral care applicator 126 within the internal cavity 123 of the handle 120. In certain embodiments, both the first and second body portions 173, 175 may pivot with respect to the handle 120.

To facilitate separating an end portion (not shown) of the oral care applicator 125 from the accordion stack 126, the first body portion 173 includes a first engagement surface 177, and the second body portion 175 includes a second engagement surface 179, both positioned to engage the oral care applicator 125 that is drawn out of the internal cavity 123. As an end portion of the oral care applicator 125 is drawn out of the internal cavity 123 and the cover 175 is altered from the open state to the closed state, by the pivoting of the second body portion 129 in this embodiment, both the first and second engagement surfaces 177, 179 engage the oral care applicator. In the embodiment shown, the first engagement surface 177 includes a slot 181 formed in a surface 183, and the second engagement surface 179 includes a cutting edge 185. When the second body portion 129 is pivoted from the open state to the closed stated, with an end portion of the oral care applicator 125 drawn out, the cutting edge 185 engages the end portion of the oral care applicator 125 at the slot 181 to cut the end portion from the remainder of the oral care applicator 125 remaining in the internal cavity 123.

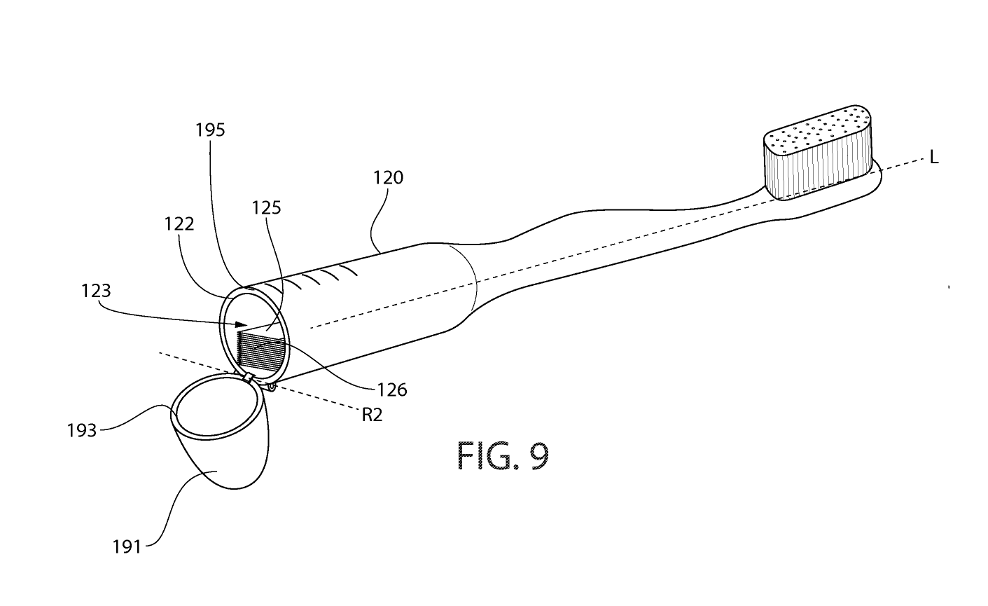

In the embodiment shown in FIG. 9, the cover 191 and the handle 120 are pivotably coupled to each other about a longitudinal axis L, so that in the closed state, the cover 191 engages the handle 120 at the dispensing aperture 122. The pivot axis R2 for the cover 191 is orthogonal to the longitudinal axis L of the handle 120. By pivoting the cover 191 to the open state, the user is given access to the accordion stack 126 of the oral care applicator 126 within the internal cavity 123 of the handle 120. To facilitate separating the end portion of the oral care applicator 125 from the rest of the oral care applicator 125 that remains in the accordion stack 126, the cover 191 includes a first engagement surface 193, and the handle 120 includes a second engagement surface 185, both positioned to engage the oral care applicator 125 as the oral care applicator 125 is drawn out of the internal cavity 123. As the cover 191 is altered from the open state to the closed state, by the pivoting of the cover 191, both the first and second engagement surfaces 193, 195 engage the oral care applicator 125. In this embodiment, the oral care applicator 125 is engaged directly between the first and second engagement surfaces 193, 195, so that the user may separate the end portion of the oral care applicator 125 from the rest of the oral care applicator 125 remaining in the accordion stack 126. The manner in which the first and second engagement surfaces 193, 195 engage the oral care applicator 125 may vary, depending upon the particular implementation. In certain embodiments, the first and second engagement surfaces 193, 195 may clamp the oral care applicator 125 directly between two surfaces. In other embodiments, the first and second engagement surfaces 193, 195 may hold the oral care applicator 125 in place between two surfaces without clamping. In yet other embodiments, one or both of the first and second engagement surfaces 193, 195 may include a cutting edge. The configuration of the first and second engagement surfaces 193, 195 are not intended to be limiting of the present invention unless so specified in the claims.

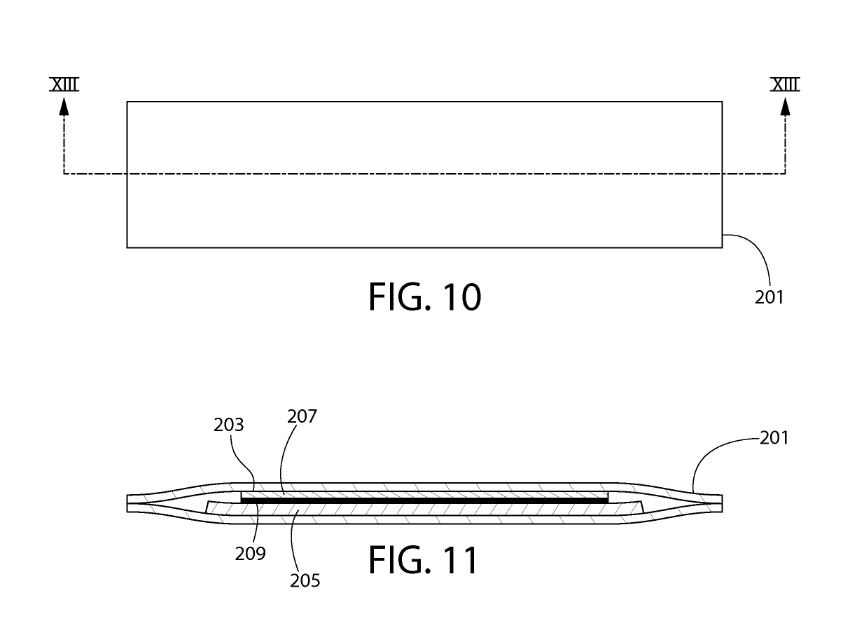

As shown in FIGS. 10-13, in certain embodiments sealed packages 201 may contain the oral care applicators 203. In the embodiment shown, the sealed package 201 is rectangular in shape, although the exact geometry of the sealed package 201 is not to be limiting of the present invention unless so specified in the claims. In certain embodiments, the sealed package 201 is hermetically sealed against incursion from external fluids and gases. Each oral care applicator 203 within each sealed package 201 includes a second substrate layer 205 to which a substrate 207 is affixed, with an oral care material 209 disposed between the substrate 207 and the second substrate layer 205. As is known in the art, the oral care material 209 may serve as an adhesive between the substrate 207 and the second substrate layer 205. In certain embodiments, the adhesive (or oral care material 209) used to affix the substrate 207 to the second substrate layer 205 also functions as an adhesive to keep the substrate on a user's teeth when the substrate 207 is placed thereon. In certain embodiments, an inner surface of the sealed package 201 may act as the second substrate layer 205, with the side of the substrate 207 having the oral care material 209 facing the inner surface of the sealed package 201. In certain embodiments, the oral care applicators 203 may not include the oral care material 209, with the user adding a desired oral care material after the oral care applicator 209 is removed from the internal cavity. Therefore, the inclusion of the oral care material on the oral care applicator is not to be limiting of the present invention unless so specified in the claims.

The oral care applicators 203 may be removed from the sealed package 201 by tearing or otherwise separating one end of the sealed package 201 from a larger portion of the sealed package 201. The separation may be facilitated by a perforation, in the sealed package 201, the choice of material for the sealed package 201, or by any suitable technique known in the art that enables a user to access the oral care applicators 203 within the sealed package 201.

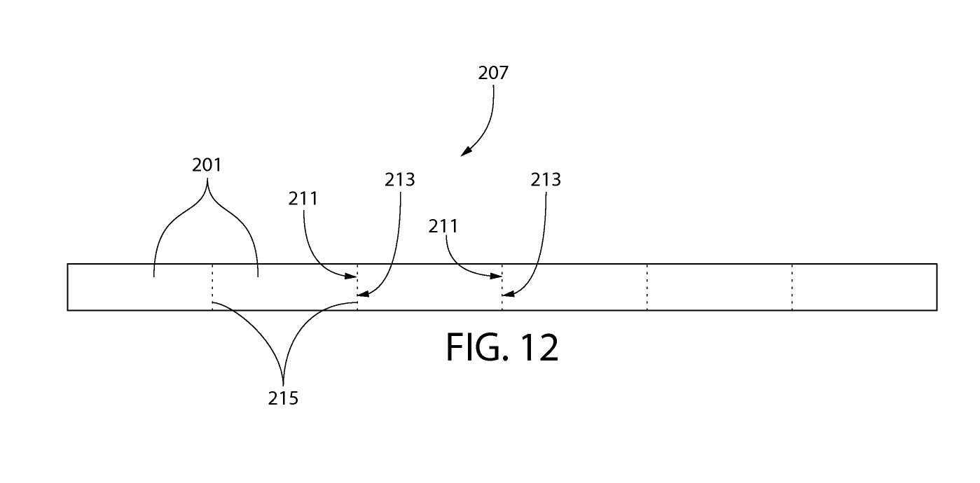

A plurality of sealed packages 201 connected to one another in an edge-to-edge arrangement 207 are shown in FIG. 12. Each sealed package 201 has a first package edge 211 and a second package edge 213 opposite the first package edge 201. The sealed packages 201 are connected in the edge-to-edge arrangement 207 such that the first package edge 211 of one sealed package 201 is connected to the second package edge 213 of a second, adjacent sealed package 201 along a pre-weakened line 215. The pre-weakened line 215 may be formed by perforations, thinned material, or by any suitable technique known in the art that facilitates separating one package form an adjacent package. This edge-to-edge arrangement 207 of the sealed packages 201 may be folded into an accordion stack for placing in the internal cavity of the handle for any embodiment of the invention.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. An oral care system comprising:
a handle comprising a proximal end, a distal end, an internal cavity, and a dispensing aperture for the internal cavity;
a head coupled to a distal end of the handle, the head comprising at least one oral surface engaging element;
a plurality of oral care applicators arranged in an accordion stack that is positioned in the internal cavity, each of the plurality of oral care applicators comprising an oral care material; and
a cover coupled to the handle, the cover being alterable between: (1) a closed state in which the cover encloses the internal cavity; and (2) an open state in which the internal cavity is exposed.

2. The oral care system according to claim 1 wherein the cover comprises:
a first body portion coupled to the handle; and
a second body portion movably coupled to the first body portion so that in the open state, an end portion of the plurality of oral care applicators is removable from the internal cavity via the dispensing aperture.

3. The oral care system according to claim 2 wherein the end portion of the one or more oral care applicators comprises an end applicator in the accordion stack.

4. The oral care system according to claim 3 wherein each of the plurality of oral care applicators comprises a substrate having the oral care material applied thereto, the substrate being removable from the internal cavity.

5. The oral care system according to claim 4 wherein each of the plurality of oral care applicators comprises a second substrate layer, the substrate removably mounted to the second substrate layer with the oral care material between the substrate and the second substrate layer.

6. The oral care system according to claim 4 wherein each of the plurality of oral care applicators is disposed in a sealed package.

7. The oral care system according to claim 2 wherein the second body portion of the cover is slidable relative to the first body portion along a longitudinal axis of the handle.

8. The oral care system according to claim 2 wherein the first and second body portions of the cover are pivotably coupled to one another about a rotational axis that is orthogonal to a longitudinal axis of the handle.

9. (canceled)

10. The oral care system according to claim 2 wherein in the closed state the first and second body portions enclose the internal cavity.

11. The oral care system according to claim 2 wherein the first body portion comprises a first engagement surface, and the second body portion comprises a second engagement surface, the first and second engagement surfaces configured to engage one of the plurality of oral care applicators therebetween when the cover is altered from the open state to the closed state.

12. The oral care system according to claim 11 wherein at least one of the first and second engagement surfaces comprises a cutting edge.

13. The oral care system according to claim 1 wherein the cover is movable with respect to the handle so that in the open state, an end portion of the plurality of oral care applicators is removable from the internal cavity via the dispensing aperture.

14. The oral care system according to claim 13 wherein the cover and the handle are pivotably coupled to one another about a rotational axis.

15. The oral care system according to claim 14 wherein the rotational axis is orthogonal to a longitudinal axis of the handle.

16. The oral care system according to claim 14 wherein the cover is pivotable with respect to the handle so that in the closed state the cover engages the handle at the dispensing aperture to enclose the internal cavity.

17. The oral care system according to claim 13 wherein the cover and the handle are slidably coupled to one another, the cover being slidable with respect to the handle so that in the open state, an end portion of the plurality of oral care applicators are removable from the internal cavity via the dispensing aperture.

18. The oral care system according to claim 17 wherein the cover is slidable with respect to the handle so that in the closed state the cover engages the handle at the dispensing aperture to enclose the internal cavity.

19. The oral care system according to claim 13 wherein the cover comprises a first engagement surface, and the handle comprises a second engagement surface, the first and second engagement surfaces being configured to engage the plurality of oral care applicators therebetween when the cover is altered from the open state to the closed state.

20. The oral care system according to claim 19 wherein at least one of the first and second engagement surfaces comprises a cutting edge.

21. An oral care system comprising:
a handle comprising an internal cavity and a dispensing aperture for the internal cavity;
one or more oral care applicators positioned in the internal cavity, the one or more oral care applicators comprising an oral care material; and
a cover slidably coupled to the handle so as to be translatable relative to the handle in a direction substantially parallel to a longitudinal axis of the handle, the cover slidable between: (1) a closed state in which the cover overlies the dispensing aperture and encloses the internal cavity; and (2) an open state in which the dispensing aperture is exposed.
